(19) United States
(12) Patent Application Publication
(10) Pub. No.: US 2019/0305682 A1
(43) Pub. Date: Oct. 3, 2019

(54) LIGHTING POWER SUPPLY DEVICE

(71) Applicant: Delta Electronics, Inc., Taoyuan City (TW)

(72) Inventors: Que WU, Taoyuan City (TW); Xiaoping FU, Taoyuan City (TW); Zhaowei CHAI, Taoyuan City (TW); Xinghua ZHANG, Taoyuan City (TW); Jinfa ZHANG, Taoyuan City (TW)

(21) Appl. No.: 16/221,628

(22) Filed: Dec. 17, 2018

(30) Foreign Application Priority Data
Mar. 29, 2018 (CN) 201810271143.4

(51) Int. Cl. H02M 3/158; F21S 2/00; H02M 1/42

(52) U.S. Cl. CPC H02M 3/158; H02M 1/42; F21S 2/005

(57) ABSTRACT

The present invention discloses a power supply device, configured to supply an output power to a plurality of lighting loads, comprising a filter rectifier module for filtering and rectifying an input voltage and outputting a rectified voltage, a plurality of power modules, and at least one dimming module. The plurality of power modules are disposed in parallel at one side of the power source device and adjacent to the plurality of power modules. Each power module includes a PFC unit for performing a power factor correction of the rectified voltage and outputting a corrected voltage; a PFC control unit for controlling the PFC unit; a DC/DC conversion unit for converting the corrected voltage into an output voltage and outputting it to the corresponding lighting load; and a DC/DC control unit for controlling the DC/DC conversion unit.

### CROSS-REFERENCE TO RELATED APPLICATIONS

This non-provisional application claims priority under 35 U.S.C. § 119(a) on Patent Application No. 201810271143.4 filed in P.R. China on Mar. 29, 2018, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The present invention relates to a lighting power supply device, and particularly to a modularized lighting power supply device.

### 2. Related Art

The high-power LED lighting is necessary for large public occasions, such as stadiums, large-scale warehouses, fishing vessels, etc. Wherein, the input voltage of power supply of high-power LED lighting generally has a very wide range and may be up to 520 VAC, which requires components with a withstand voltage above 1 KV. The high-voltage silicon MOS can meet the requirements, but they are very expensive and available from very few manufacturers. Besides, the lighting power supplies are required to be naturally cooled in extreme environments where the working temperature may reach −40° to +70°. Additionally, some power supplies even require to be light-weighted, so they cannot be processed with potting materials, and could only dissipate the heat through the housing, resulting in heat dissipation problems of the components in the entire lighting power supply. Moreover, such a high-power LED lighting power supply is substantially applied in outdoors, which requires to meet a protection level of IP67 so as to enhance its moisture-proof and rain-proof capabilities, etc.

In the prior art, a power supply device of the high-power LED lighting generally uses a structure of one-input and one-output. With respect to this structure, in order to solve the problems of heat dissipation, the radiating fins on the housing are required to be enlarged. Additionally, such a structure of one-input and one-output is not flexible.

Referring to FIG. 1, which is a structure schematic diagram of a conventional lighting power supply device. As shown in FIG. 1, the conventional lighting power supply device includes: an EMI filter circuit 111, a bridge rectifier circuit 112, a PFC unit 121, a DC/DC conversion unit 122, a PFC control unit 123, a DC/DC control unit 124, and a dimming unit 14. The operating principle of the device is that a wide-range input voltage is converted into a full-wave voltage through the EMI filter circuit 111 and the bridge rectifier circuit 112, corrected by the PFC unit 121, and then partially converted into a DC voltage by the DC/DC conversion unit 122 to control a LED light 13.

However, a drawback of the above conventional lighting power supply device is that if the power is supplied to a plurality of LEDs, an external shunt is needed for shunting and supplying power to the plurality of LEDs 13 separately. Further, the input voltage of the power supply has a quite wide range, it is necessary to use MOS transistors with high voltage withstand and large current. However, such MOS transistors are expensive and can only be available from very few manufacturers. Furthermore, in order to dissipate heat, it is necessary to enlarge the radiating fins on the housing of the power supply, which increases the height and weight of the high-power LED lighting power supply. Moreover, the lighting power supply with such a structure is not flexible and it is difficult to compatible with different specifications with different power demand. In addition, it is hard to change color with such a structure of the lighting power supply.

Therefore, there is an urgent demand for developing a lighting power supply device that overcomes the above deficiencies.

### SUMMARY OF THE INVENTION

In order to overcome the above-mentioned problems conventional in the prior art, it is an object of the present invention to provide a power supply device which provides an output power to a plurality of lighting loads, comprising at least one filter rectifier module configured to filter and rectify an input voltage and output a rectified voltage, a plurality of power modules electrically coupled to the filter rectifier module, and at least one dimming module electrically coupled to the DC/DC control unit. The plurality of power modules are disposed in parallel at one side of the power source device and adjacent to the filter rectifier module. Each power module includes a PFC unit configured to perform a power factor correction on the rectified voltage and output a corrected voltage, a PFC control unit electrically coupled to the PFC unit for controlling the PFC unit, a DC/DC conversion unit electrically coupled to the PFC unit and a corresponding lighting load, and configured to convert the corrected voltage into an output voltage and output it to the corresponding lighting load; and a DC/DC control unit electrically coupled to the DC/DC unit for controlling the DC/DC conversion unit.

It is to be understood that both the foregoing general description and the following detailed description are by examples, and are intended to provide further explanation of the disclosure as claimed.

### BRIEF DESCRIPTION OF THE DRAWINGS

FIG. 1 is a structure schematic diagram showing a conventional lighting power supply device;

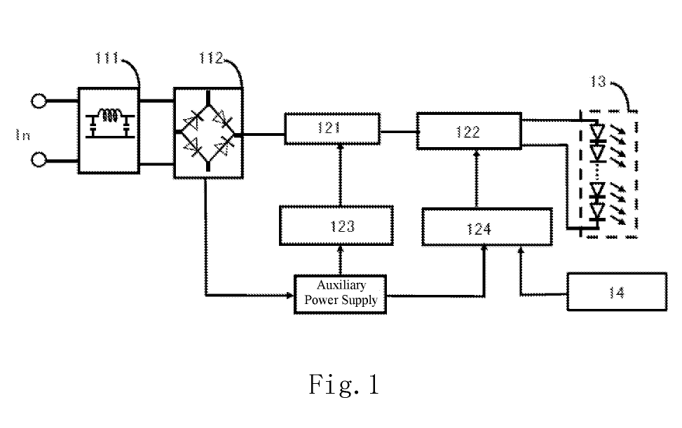

FIG. 2 is a structure schematic diagram showing a circuit of a power supply device according to a first embodiment of the present disclosure;

FIG. 3 is a structure schematic diagram showing a hardware structure of FIG. 2;

FIG. 4 is a structure schematic diagram showing a circuit of the power supply device according to a second embodiment of the present disclosure;

FIG. 5 is a structure schematic diagram showing three outputs of the power supply device according to the present disclosure;

FIGS. 6-8 are schematic diagrams showing structures of different output power of the power supply device according to the present disclosure;

FIG. 9 is a schematic diagram showing a warm-cold mixed color of the power supply device according to aspects of the present disclosure; and

FIG. 10 is a schematic diagram showing an RGB mixed color of the power supply device according to aspects of the present disclosure.

### DETAILED DESCRIPTION OF THE INVENTION

Hereinafter, the present invention will be further described in detail with reference to the accompanying drawings and the specific embodiments. The embodiments were carried out on the premise of the technical solution of the present invention, and implementations and operation processes are provided. However, the protection scope of the present invention is not limited to the following embodiments.

Noted that the numbers of power modules, filter rectifier modules, and LED lights that will be described below are only an implementation of the present invention, and those skilled in the art can absolutely adjust the numbers of the above elements according to the usage requirements under the concept of the present invention, thus the present invention does not limit the numbers of power modules, filter rectifier modules and LED lights.

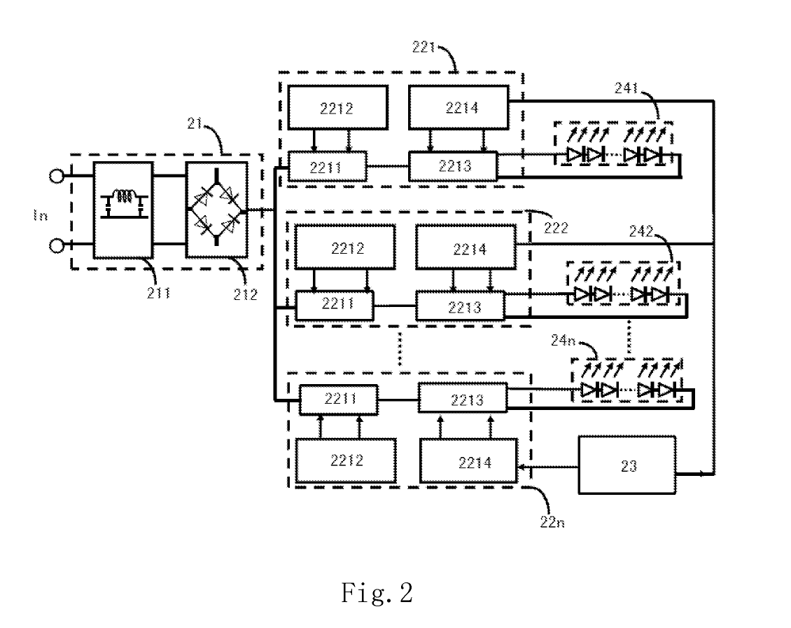

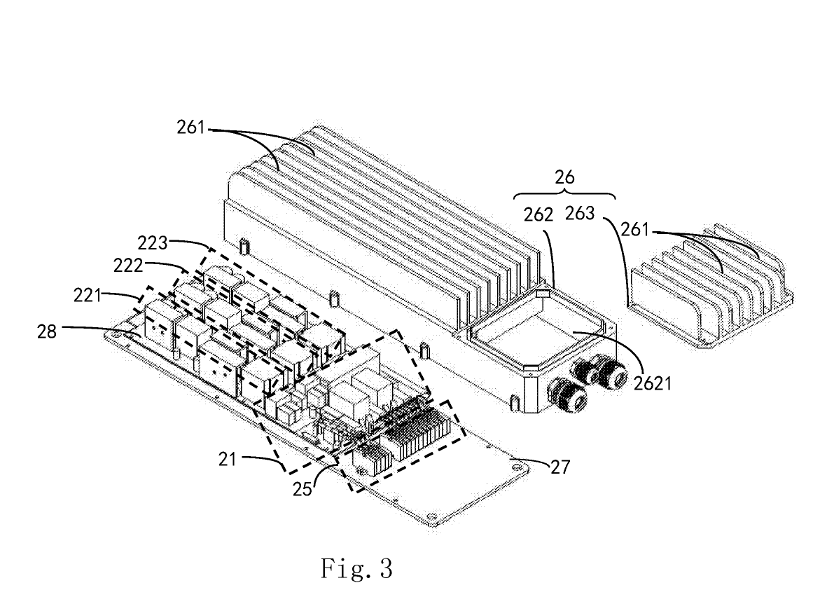

Referring to FIGS. 2 and 3, FIG. 2 is a structure schematic diagram showing a circuit of a power supply device according to a first embodiment of the present invention, and FIG. 3 is a structure schematic diagram showing a hardware structure of FIG. 2. In FIG. 3, an example in which the lighting power supply device includes three power modules 221, 222, 223 is illustrated, but the present disclosure is not limited thereto.

As shown in FIGS. 2-3, the lighting power supply device according to the present disclosure is configured to provide an output power to a plurality of lighting loads 241, 242, . . . 24n, and the power supply device is usually applied to high-power LED fields, for example, stadium lights, searchlights, fishing lights, or a street lamps.

The lighting power supply device comprises a filter rectifier module 21, a plurality of power modules 221, 222, . . . , 22n, and at least one dimming module 23, where n is a positive integer. The filter rectifier module 21 is connected to an input power supply via a connection port 25. The filter rectifier module 21 is used for filtering and rectifying an input voltage and outputting a rectified voltage. The plurality of power modules 221, 222, . . . , 22n are disposed in parallel with each other at one side of the power supply device, and electrically coupled to the filter rectifier module 21. The filter rectifier module 21 is disposed adjacent to the plurality of power modules. Each power module includes a PFC unit 2211, a PFC control unit 2212, a DC/DC conversion unit 2213 and a DC/DC control unit 2214. The PFC unit 2211 is configured to perform a power factor correction on the rectified voltage and output a corrected voltage. The PFC control unit 2212 is electrically coupled to the PFC unit 2211 for controlling the PFC unit 2211. The DC/DC conversion unit 2213 is electrically coupled to the PFC unit 2211, and a corresponding lighting load, for converting the corrected voltage into an output voltage and outputting it to the corresponding lighting load. The DC/DC control unit 2214 is electrically coupled to the DC/DC unit 2213 for controlling the DC/DC conversion unit 2213. The dimming module 23 is electrically coupled to all of the DC/DC control unit 2213. In this embodiment, only one filter rectifier module 21 is provided, but the disclosure is not limited thereto.

In this embodiment, only one dimming module 23 is provided, but the present disclosure is not limited thereto. In other embodiments, a plurality of dimming modules may be provided. The number of the plurality of dimming modules may be the same as the number of the power modules, and each dimming module is electrically coupled to a respective DC/DC control unit.

Further, the filter rectifier module 21 includes an EMI filter circuit 211 and a rectifier circuit 212. The EMI filter circuit 211 is used to filter the input power supply. The rectifier circuit 212 is electrically coupled to the EMI filter circuit 211 for rectifying an input voltage and outputting the rectified voltage.

In this embodiment, each power module may output the same output power and output current, but the present disclosure is not limited thereto. In other embodiments, each power module may output different output power and different output current.

Further still, the lighting loads is LEDs, but the present disclosure does not limit the type of the loads.

Furthermore, the lighting power supply device may further comprise a housing 26 and a base board 27 on which the filter rectifier module 21, the plurality of power modules 221 . . . 22n and the dimming module 23 are disposed. The connection port 25 is disposed on the base board 27 and is close to the filter rectifier module 21. The housing 26 covers the filter rectifier module 21, the plurality of power modules 221 . . . 22n, the dimming module 23, and the connection port 25. The housing 26 is provided thereon with a plurality of radiating fins 261 to dissipate heat from the lighting power supply device. However, the present disclosure is not limited thereto. In some embodiments, each of the filter rectifier module 21, the plurality of power modules 221 . . . 22n, and the dimming module 23 may be disposed on an individual circuit board 28, respectively. A plurality of the circuit boards 28 are all locked and secured to the base board 27. Alternatively, all the filter rectifier module 21, the plurality of power modules 221 . . . 22n, and the dimming module 23 may be disposed on one circuit board 28. The circuit board 28 is then locked and secured to the base board 27. However, the present disclosure is not limited thereto.

In this embodiment, the housing 26 may further comprise a body 262 and a lid 263. The body 262 covers the filter rectifier module 21, the plurality of power modules 221 . . . 22n, the dimming module 23, and a portion of the wiring port 25, and the housing 26 is locked and secured to the base board 27 via screws. The body 262 has an opening 2621 which at least exposes a portion of the wiring port 25, and the lid 263 is detachably mounted on the opening 2621 to facilitate later maintenance and repair. Both the body 262 and the lid 263 are provided thereon with a plurality of radiating fins 261.

In this embodiment, the lighting power supply device dissipates heat by natural cooling and is not provided with any heat dissipation structure such as a liquid cooling plate, a fan or the like.

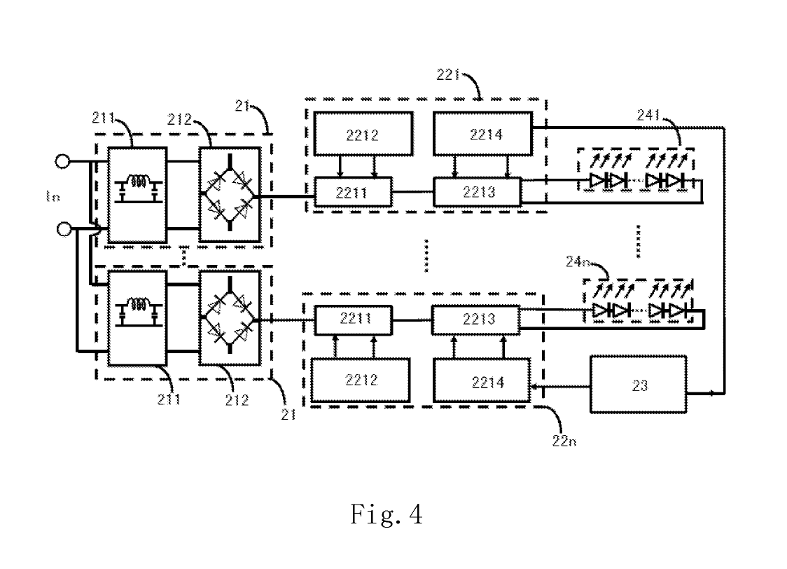

FIG. 4 is a structure schematic diagram showing a circuit of the lighting power supply device according to a second embodiment of the present disclosure. The lighting power supply device shown in FIG. 4 is substantially the same as the lighting power supply device shown in FIG. 2 in terms of structure, thus the same parts will not be repeated here while the different parts are now explained below. As shown in FIG. 4, in this embodiment, the number of the filter rectifier modules 21 is the same as the number of the power modules, and each filter rectifier module 21 is electrically coupled to a corresponding power module.

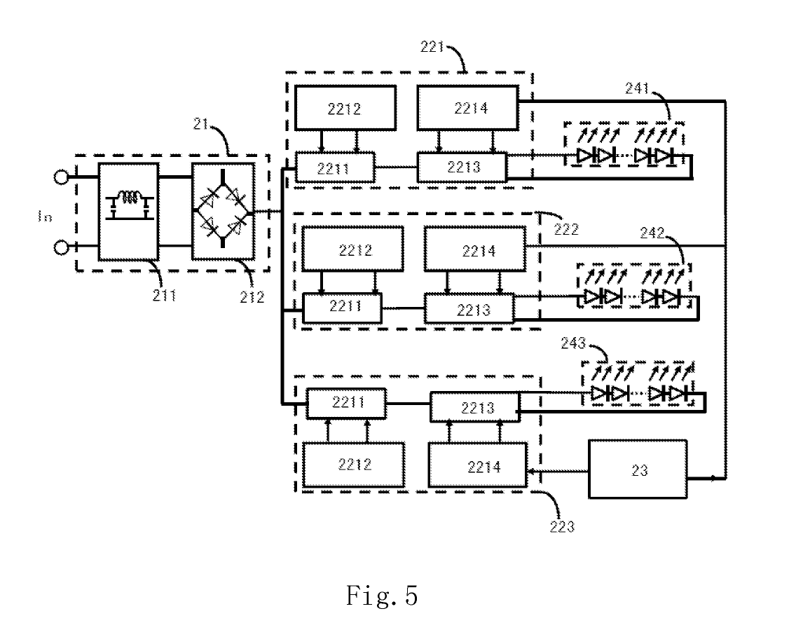

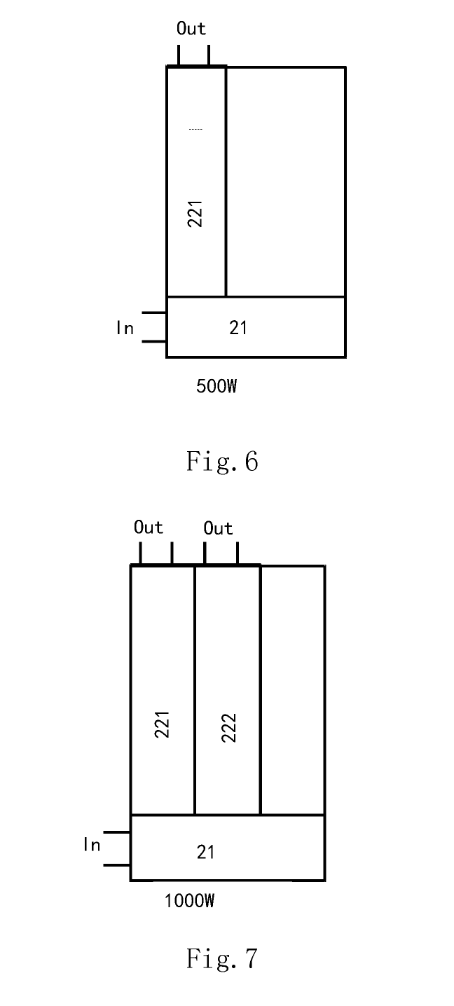

Referring to FIGS. 5-8, FIG. 5 is a structure schematic diagram showing three outputs of a circuit of the lighting power supply device according to the present disclosure. As shown in FIG. 5, the lighting power supply device comprises three power modules 221, 222, 223 and three lighting loads 241, 242, 243. The power modules 221, 222, 223 are electrically connected to the lighting loads 241, 242, 243 in one-to-one correspondence. FIGS. 6-8 are schematic diagrams showing structures of different output power of the power supply device according to the present disclosure. As shown in FIG.6, when load demand is small, for example, the power of the lighting load is 500 W. In such a case, one power module 221 can satisfy the power demand. As shown in FIG. 7, when load demand, for example, is 1000 W, the requirements to the power supply may be rapidly satisfied by the power modules 221, 222. As shown in FIG. 8, when the load demand is 1500 W, the output power of each power module is set to 500 W, and the three power modules 221, 222, 223 can quickly meet the requirements. Likewise, the output power may be configured to, for example, 500 W, 1000 W, 1500 W or more by connecting a plurality of power modules in parallel. In this way, the customers' requirements for the power of 500 W, 1000 W, 1500 W or more may be rapidly satisfied. Further, it is convenient for producing and manufacturing. Here, a power of 500 W is taken as an example, but the present disclosure is not limited thereto.

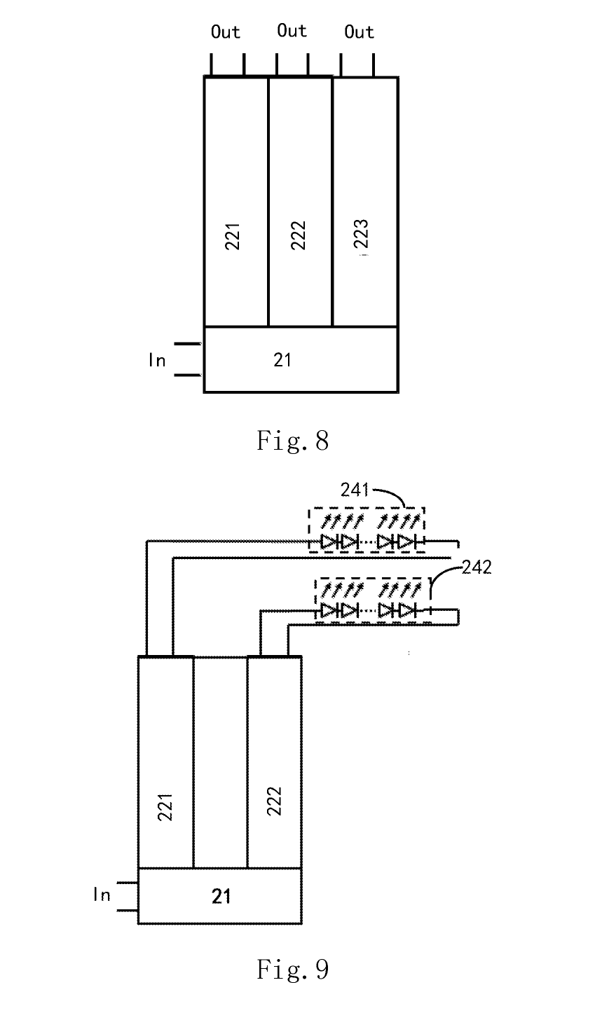

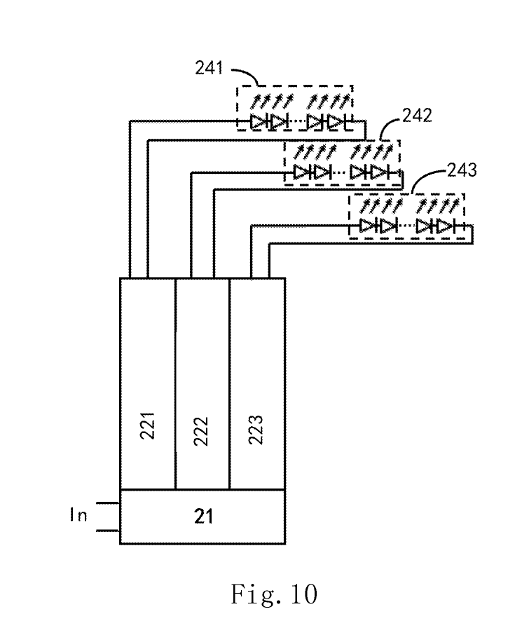

Referring to FIG. 5 and FIG. 9, FIG. 9 is a schematic diagram showing a warm-cold mixed color of the lighting power supply device according to the present disclosure. The plurality of lighting loads include at least one cold-colored LED and one warm-colored LED. As shown in FIG. 9, when the loads demand the warm-cold mixed color, such effects may be achieved by connecting the power module 221 of the lighting power supply device to a cold-colored LED 241, connecting the power module 222 to a warm-colored LED 242. Further, referring to FIG. 5 and FIG, 10. FIG. 10 is a schematic diagram showing an RGB mixed color of the power supply device according to the present disclosure. The plurality of lighting loads include at least one red LED light, one green LED light, and one blue LED light. As shown in FIG. 10, when the effect of the loads with an RGB mixed color is needed, which can be achieved by connecting three power modules 221, 222, and 223 of the power supply device to a red LED 241, a green LED 242, and a blue LED 243, respectively. As can be seen, a mixed-color in high-power LED power supply with cold colors and warm colors can be easily implemented by setting two power modules connected in parallel. Further, an RGB mixed-color in high-power LED power supply can be easily implemented by setting three power modules connected in parallel.

Wherein the above embodiment for implementing color mixing effects is only an example of the present disclosure, and the present disclosure is not limited thereto. In other embodiments, a designer may also make modifications according to practical requirements.

In summary, with the lighting power supply device according to the present disclosure, different output power can be achieved by connecting a plurality of power modules in parallel. In this way, the customers' requirements for the power, for example 500 W, 1000 W, 1500 W or more may be quickly satisfied. Further, it is convenient for producing and manufacturing. For another, it is possible to realize a mixed-color in high-power LED power supply with cold colors and warm colors by setting two power modules connected in parallel, and to realize an RGB mixed-color in high-power LED power supply by setting three power modules connected in parallel, allowing a more flexible design for the lighting power supply. From another aspect of the present disclosure, with a modularized structure, the heat of each components can be uniformly distributed, so as to disperse heat quickly, thereby solve the heat dissipation problem of the product which is required to be naturally cooled in extreme environments. And it is possible to use a housing with smaller radiating fins, thereby reducing height and weight of a high-power LED power supply and satisfying the requirements for light weight.

It should be noted that the above embodiments are only intended to illustrate the present invention but not to limit the technical solution described in the present invention; moreover, although the present invention is described in detail with reference to the above embodiments in this specification, the ordinary persons skilled in the art should understand that modifications or equivalent substitutions can still be made to the present invention; thus, all the technical solutions not departing from the spirit and scope of the present invention and the improvements thereof should be covered by the protection scope of the appended claims of the present invention.

What is claimed is:

1. A lighting power supply device, which provides an output power to a plurality of lighting loads, comprising:
at least one filter rectifier module configured to filter and rectify an input voltage and output a rectified voltage;
a plurality of power modules electrically coupled to the filter rectifier module, wherein the plurality of power modules being disposed in parallel at one side of the lighting power source device and adjacent to the filter rectifier module, each power module including:
a PFC unit configured to perform a power factor correction on the rectified voltage and output a corrected voltage;
a PFC control unit electrically coupled to the PFC unit for controlling the PFC unit;
a DC/DC conversion unit electrically coupled to the PFC unit and a corresponding lighting load, configured to convert the corrected voltage into an output voltage and output it to the corresponding lighting load; and
a DC/DC control unit electrically coupled to the DC/DC conversion unit, and configured to control the DC/DC conversion unit; and
at least one dimming module electrically coupled to the DC/DC control unit.

2. The lighting power supply device according to claim 1, wherein the filter rectifier module includes:
an EMI filter circuit configured to filter the input voltage; and
a rectifying circuit electrically coupled to the EMI filter circuit, configured to rectify the input voltage and output the rectified voltage.

3. The lighting power supply device according to claim 1, wherein the number of the filter rectifier modules is the same as the number of the power modules, and each of the filter rectifier modules is electrically coupled to a corresponding power module.

4. The lighting power supply device according to claim 1, wherein each power module outputs the same output power and output current.

5. The lighting power supply device according to claim 1, wherein respective power modules output different output powers and different output currents.

6. The lighting power supply device according to claim 1, wherein the plurality of lighting loads are LEDs.

7. The lighting power supply device according to claim 6, wherein the plurality of lighting loads include at least one cold-colored LED and one warm-colored LED.

8. The lighting power supply device according to claim 6, wherein the plurality of lighting loads include at least one red LED, one green LED, and one blue LED.

9. The lighting power supply device according to claim 1, wherein the power supply device dissipates heat by natural cooling.

10. The lighting power supply device according to claim 1, wherein the power supply device is suitable for a stadium light, a searchlight, a fishing light, or a street lamp for high-power LED fields.

11. The power supply device according to claim 1, further comprising a base board on which the filter rectifier module, the dimming module and the plurality of power modules are disposed.

12. The power supply device according to claim 11, further comprising a housing locked to the base board, and the housing configured to cover the filter rectifier module, the dimming module and the plurality of power modules.

13. The power supply device according to claim 1, wherein the number of the dimming modules is the same as the number of the power modules, and each dimming module is electrically coupled to a corresponding DC/DC control unit.
